(19) United States
(12) Patent Application Publication
(10) Pub. No.: US 2014/0192517 A1
(43) Pub. Date: Jul. 10, 2014

(54) BELT WITH LIGHT

(71) Applicant: Sonia Angelica Alvarado, North Hills, CA (US)

(72) Inventor: Sonia Angelica Alvarado, North Hills, CA (US)

(21) Appl. No.: 13/735,263

(22) Filed: Jan. 7, 2013

(51) Int. Cl. F21V 33/00

(52) U.S. Cl. CPC F21V 33/0008
USPC 362/103

(57) ABSTRACT

An adjustable belt worn around the waist of a person with a light attached to the front of the belt. The belt is made of webbing material and has a plastic side-release buckle adjustable on one side. The light is a light-emitting diode (LED) lamp. By pushing a single-button the user can easily select between various lighting modes. The lamp tilts up and down and is powered by batteries contained within the lamp. One embodiment of the belt with light has a minimum of two metal snaps, one on each side of the lamp. The snaps are to attach accessories to the belt such as a whistle, keychain, pouch, and/or small bag. The purpose of the belt with light is to provide bright hands-free illumination for any situation where this is needed or preferred, such as emergencies, dog walking, running, hiking, camping, and household chores.

### CROSS-REFERENCE TO RELATED APPLICATION

This application claims the benefit of Provisional Application No. 61/584,181 filed on Jan. 6, 2012 in the name of inventor Sonia Alvarado.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

This invention is in the field of hands-free illumination devices worn around the waist for safety and utility purposes. The bright light emanating from the belt provides the wearer with better visibility under poor lighting conditions. The belt illuminates a path extending an excess of twelve meters and can be worn to light a path when walking a dog, participating in athletic activities such as running and hiking, camping, for emergencies, or performing basic tasks, like watering plants at night.

People need light to perform many tasks safely and efficiently in the evening or in dark places. These tasks and activities include finding their shoes and their way to safety during an earthquake and power outage; checking circuit breakers when the lights go out; walking the dog in the evening; going for a run before sunrise; and taking out the trash at night.

The most widely used portable lighting device has been the flashlight. The problem with a flashlight is that it requires users to hold it in their hand. In many instances people need to have their hands free to perform tasks. The dog walker holds the dog with one hand and needs the second hand to pick up after the dog, hold a walking stick or a second dog. In an emergency, one needs both hands to grab things or secure children and pets. A person going for a power-walk or run swings his arms as part of the exercise and holding a flashlight interferes with that. A lighting device that provides hands-free operation is the headlamp. Inspired by miners' lights, this is worn on the head, strapped to the forehead with one or two elastic bands. Some people don't want to use these lights simply because of vanity: they feel they look silly walking around with a light on their forehead and they don't want to disturb their hair style with the straps around their head. Another disadvantage is that when walking with a companion, one is likely to shine the light in the other's eyes during conversation. Headlamps sometimes feel uncomfortable and may cause added perspiration from the forehead especially during exercise.

A few products have been created for dog walking at night. There are lights that hang from the dog's collar. However, illumination from a moving dog may not provide a steady light beam for the person walking the dog. Furthermore, a dog might be lighting a bush, while the owner trips on the dark sidewalk. There are a few retractable leashes with a light. However, not everyone likes to use retractable leashes, especially when walking multiple dogs as they may be hard to hold. Again, there is often too much movement from a hand that walks a dog in order to steadily light the path for the dog walker.

Several novelty and safety illuminated belts are known. For example, European patent no. EP 0129920 A1 by Arie Valkenburg (published on Jan. 2, 1985) teaches a light reflecting safety belt. The light reflecting safety belt comprises two co-operating portions of a touch and dose fastener. The operative face of one fastener portion lies at one side of the safety belt, while the operative face of another fastener portion lies on the other side of the safety belt. One side of the safety belt is provided with at least one light reflecting strip-shaped portion that extends only over a part of the width of the safety belt. The problem with this invention is that a light strip does not provide a source of light for a person walking down a dark path, but only makes a person visible in the dark to others. Thus, a person can easily get injured walking in the dark with the Valkenburg invention.

Also known is U.S. Pat. No. 6,260,978 B1 (issued on Jul. 17, 2001) to St. John, which teaches a Battery Power and Light Belt. The belt has rechargeable batteries thereon and is connected to a light to be worn on the cap of the hunter as well as a flood light to be carried by the hunter. The invention also has a third light which may be used to illuminate a walking area. The first two lights provide different levels of illumination. Again, the problem here is that a user must wear a lighting apparatus on his or her head, which interferes with a person's hair and causes light to be flashed in the face of the person to whom the user is speaking. With the light source on a belt, these problems are solved. Moreover, the St. John requires the use of cables to connect the head lamp to the light belt, which can interfere with the movements of the user.

Finally, U.S. Pat. No. 4,283,756 (issued on Aug. 11, 1981) to Beamon teaches a Flashing-Light Belt. The belt includes the usual flexible strip and buckle. A flashing-light means is mounted in the buckle and is powered by a portable power supply, which may be located in the wearer's pocket. Preferably the light means takes the form of two associated flasher circuits. The problem with Beamon is that it requires the user to have a pocket or other location in which to insert a portably power supply. The portable power supply being connected to the belt and inserted into a pocket can interfere with the movement of the user. Moreover, the Beamon invention would not useful if the user does not have a pocket or place to insert a portable power supply. Beamon also does not have the ability to pivot the light source up and down, nor is it equipped with accessories.

The present invention solves these problems in that it does not require placement of a battery supply in another location of the user's body, thereby avoiding the use of cables or wires about the user's body that may interfere with the user's movements. The light is also worn on the belt, which avoids the problem of flashing the light in a person's face when the user speaks to another person in the dark, and avoids the problem of interfering with a person's hair style. It provides hand's free illumination with several useful features, including the ability to pivot the light up and down and to attach accessories. By utilizing non-stretch belt webbing, the problem of bouncing lighting is avoided for runners, joggers, and fast hikers.

### SUMMARY

The present invention is a belt with a light that is worn around the waist. The first embodiment of the belt with light is adjusted to fit almost every body type and can be worn over clothing such as a t-shirt or a winter jacket. The side release belt buckle is adjustable on one side. Attached to the front center of the belt is an LED lamp with 18 white bulbs that can light from 1 to 40 feet ahead or down. Future embodiments may include other LED lamps with 4, 8 or 12 bulbs and may combine white and red bulbs. The lamp has a one-button operation feature which allows the user to select between using 4 bulbs, 8 bulbs 18 bulbs and 18 bulbs flashing. The lamp tilts up and down to point the light beam where needed. Three batteries power the lamp and are contained in a battery compartment within the lamp. One embodiment of the belt has optional metal snaps to secure various accessories. Accessories presently include: a metal whistle, a key chain and a storage pouch or bag.

### BRIEF DESCRIPTION OF THE DRAWINGS

FIG. 1 is a perspective view of a belt with light according to the present invention

FIG. 2 is a front elevational view of the belt with light of FIG. 1

FIG. 3 is a rear elevational view of the belt with light of FIG. 1

FIG. 4 is a right side elevational view of the belt with light of FIG. 1

FIG. 5 is a left side elevational video of the belt with light of FIG. 1

FIG. 6 is a top plan view of the belt with light of FIG. 1

FIG. 7 is a bottom plan view of the belt with light of FIG. 1

FIG. 8A is a partial sectional view of the LED lamp displaying the tilt up position of the lamp

FIG. 8B is a partial sectional view of the LED lamp displaying the tilt down position of the lamp

FIG. 9 perspective view of person wearing belt with light around the waist

FIG. 10 is a rear perspective view of belt with light of FIG. 1

FIG. 11 is a right side view of battery compartment outside the lamp

FIG. 12 is a perspective view of an alternative embodiment of belt with light with snaps according to the present invention

FIG. 13 is a rear perspective view of the alternative embodiment of the present invention

FIG. 14 is a back view of optional accessories for FIG. 12, and alternative embodiment of the present invention

FIG. 15A front elevational view of whistle with snap for FIG. 12

FIG. 15B rear elevational view whistle with snap for FIG. 12

FIG. 16A front elevational view of keychain with snap for FIG. 12

FIG. 16B rear elevational view of keychain with snap for FIG. 12

FIG. 17A front elevational view of small pouch with snap for FIG. 12

FIG. 17B rear elevational view of small pouch with snap for FIG. 12

FIG. 18A front elevational view of large pouch with snap for FIG. 12

FIG. 18B rear elevational view large pouch with snap for FIG. 12

### REFERENCE NUMERALS

19 belt with light
20 LED bulbs
25 base of lamp
26A belt webbing
26B excess belt webbing
27 buckle
28 keeper
29 light-emitting diode (LED) lamp
30 push button
31 right side of lamp
32 left side of lamp
33 top side of lamp
34 bottom side of lamp
35 rear side of lamp
36A right belt hook
36A left belt hook
37A right snap
37B left snap
38 twist-off side access to battery compartment
39 battery compartment
40 cavity housing battery compartment
41 keychain accessory with snap
42 whistle accessory with snap

### DETAILED DESCRIPTION

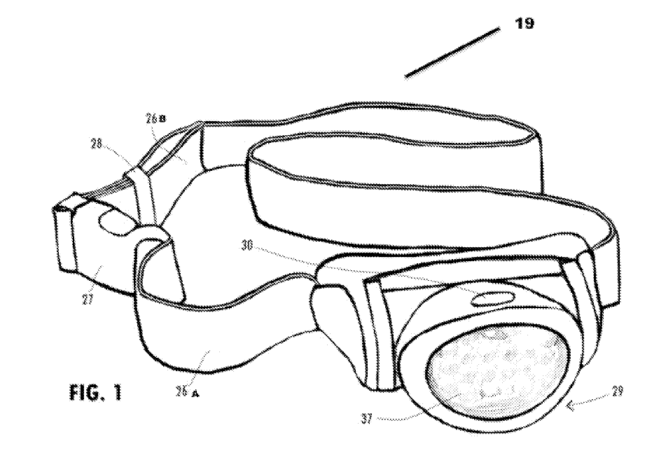

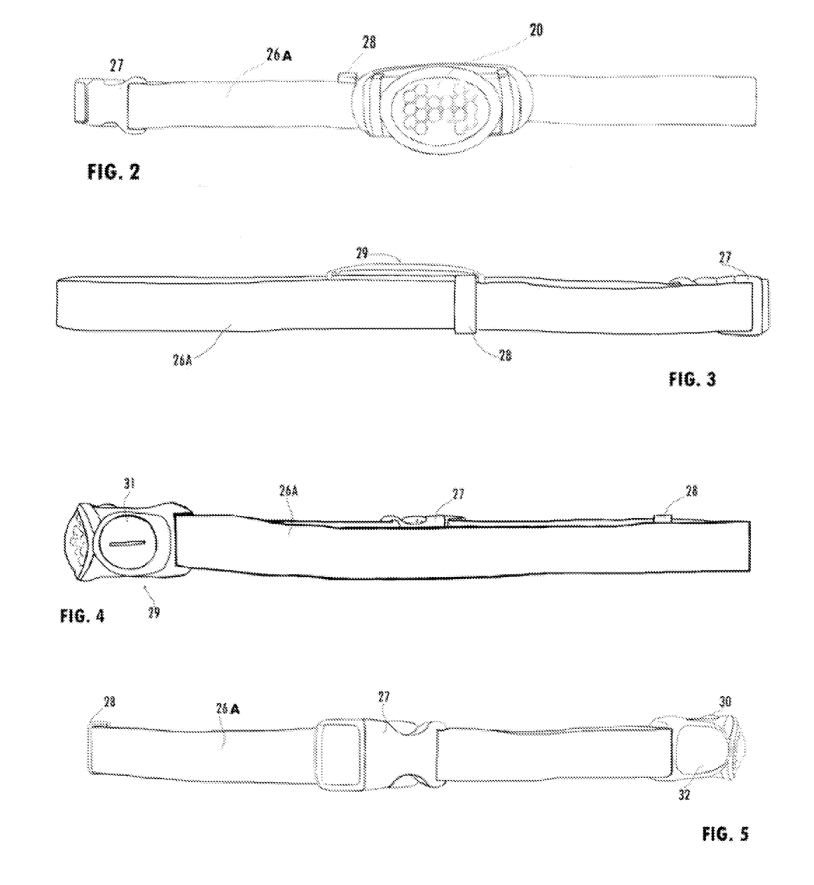

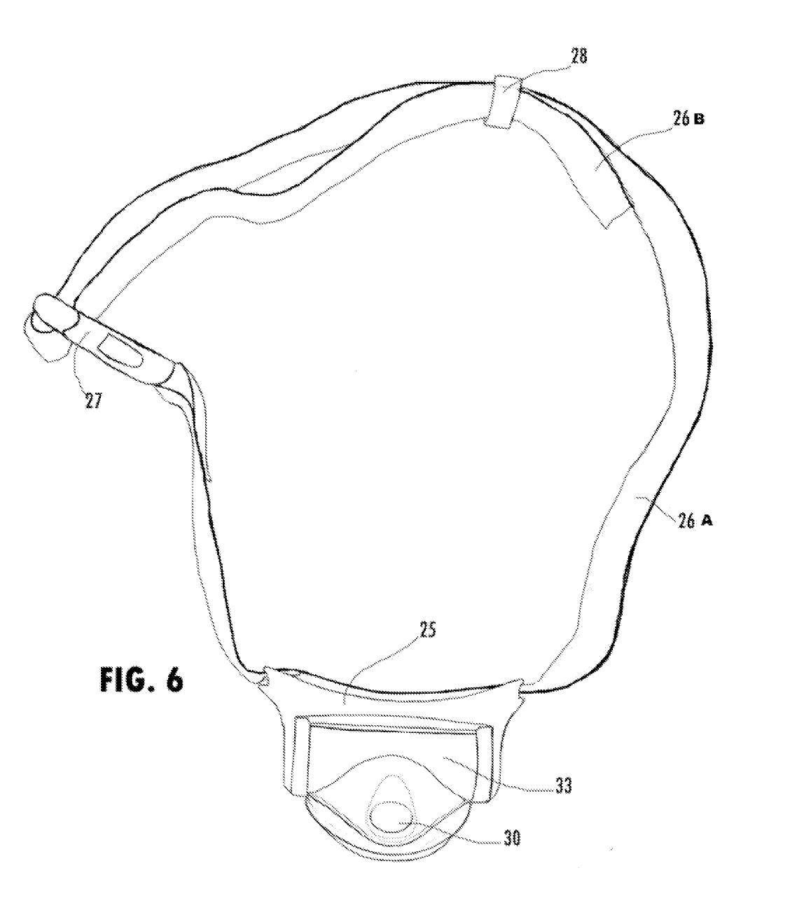

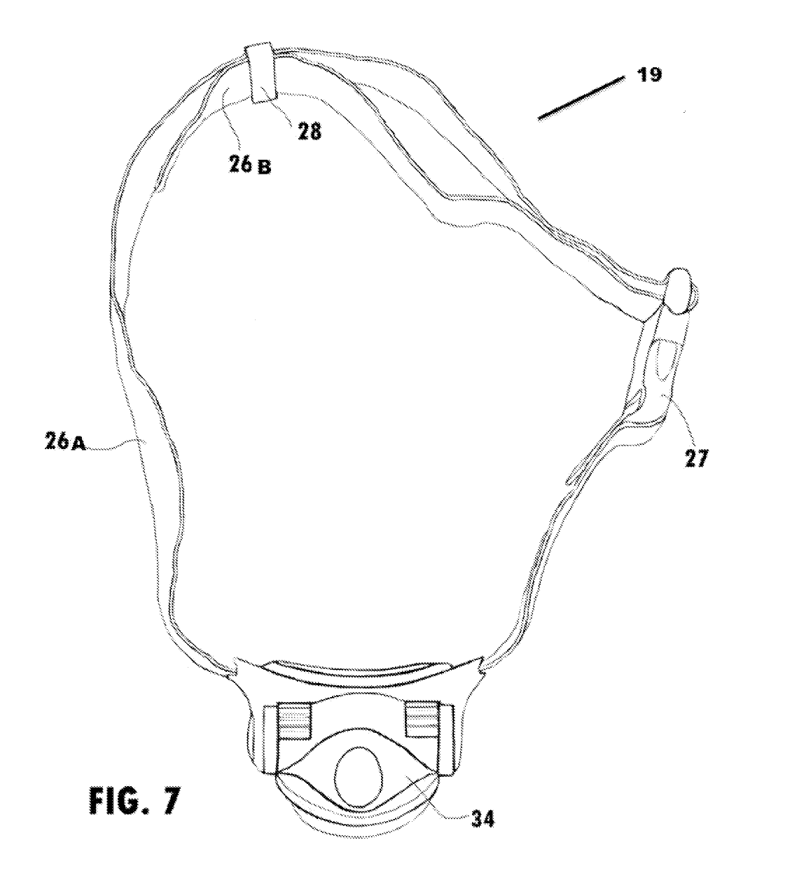

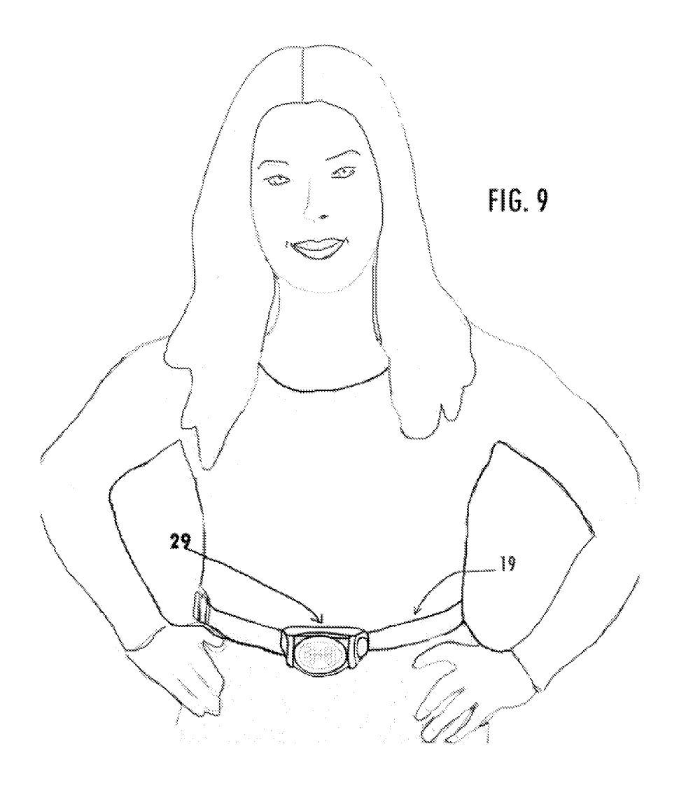

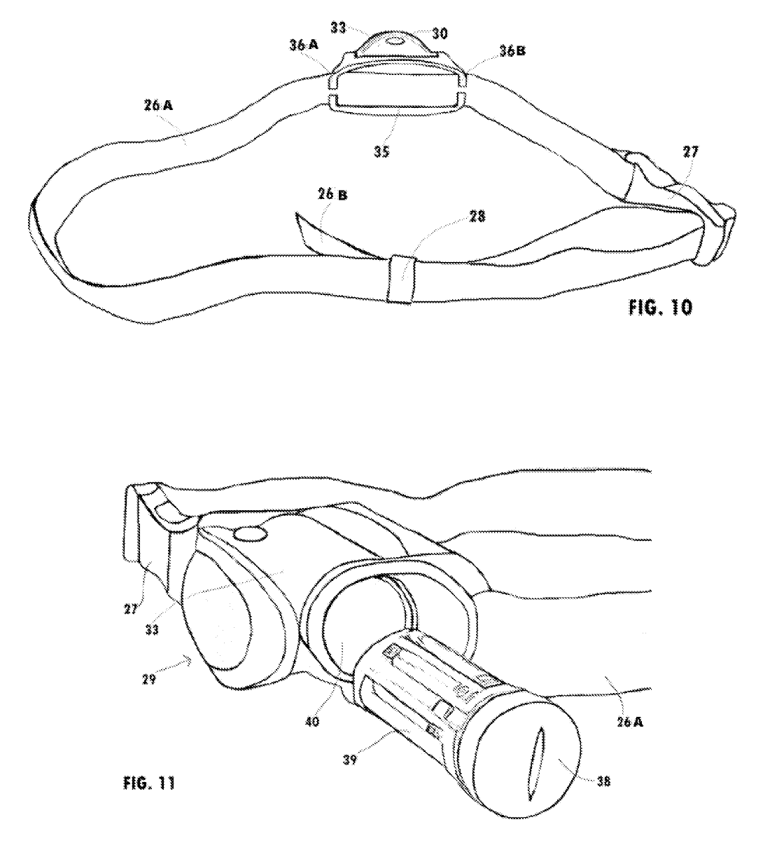

A first embodiment of the belt with light of the present invention is illustrated in FIGS. 1-11 and indicated by the number 19. The belt consists of durable belt webbing 26A material. The belt material of this embodiment may be made of nylon webbing, but other materials are also suitable. The webbing material is preferably one inch wide and may be fabricated in different lengths to fit around the waist of men, women and children. The belt is adjustable and includes excess belt webbing 26B, preferably about 23 cm in length, which is looped through an adjustable side-release plastic buckle 27 and held in place by a plastic belt keeper 28. The light is a bright, energy-efficient, light-emitting diode (LED) lamp 29 with a plurality of LED bulbs 20 as shown on FIG. 2. The lamp is attached to the belt webbing 26A so that when someone wears the belt, as shown on FIG. 9, the lamp 29 is positioned at the front center of the belt and the buckle 27 is positioned on the right side of the body for easy access. The push button 30 that operates the lamp is located on the top of the lamp 33. The lamp is secured onto the belt by looping the belt webbing 26A through the right belt hook 36A and left belt hook 36B, located on the rear side of the lamp 35 (FIG. 10). The belt webbing material 26A is attached to the belt buckle 27, by looping it through the adjustable side of the buckle and looping it through the nonadjustable side and sewing it to keep it secured.

The LED lamp 29 is powered by batteries contained inside the lamp and housed in a battery compartment 39 that twists loose and slides out (FIG. 11). The twist access 38 to the battery compartment is located on the right side of the lamp 31 (FIG. 4).

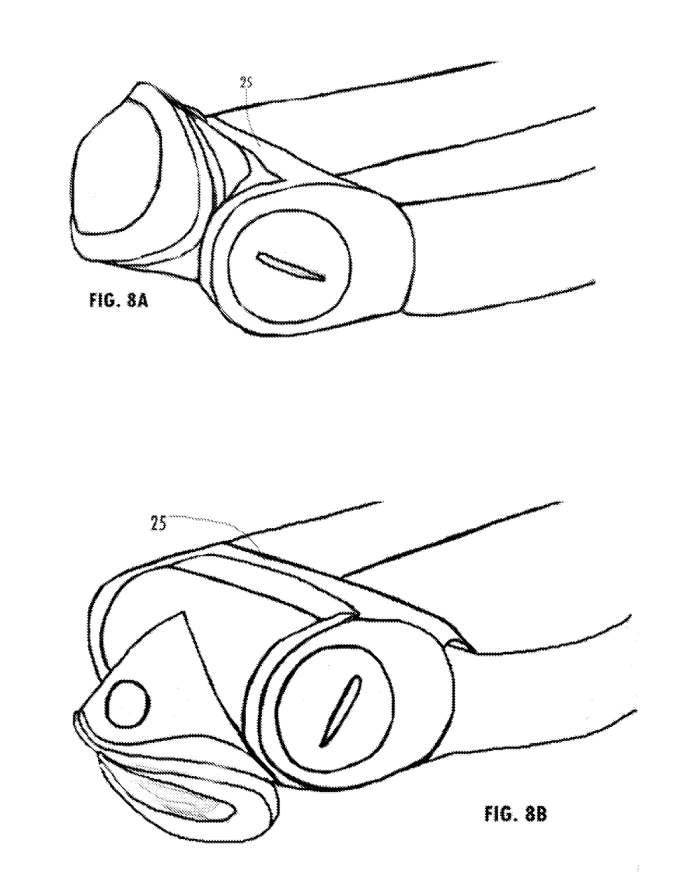

The belt with light is worn around the waist (FIG. 9) and secured by an adjustable side release buckle 27. There is no need for belt loops since the belt is worn over clothes. The light emanating from the belt comes from a light-emitting diode lamp 29 with a plurality of LED bulbs 20 that can illuminate a path of over twelve meters ahead. The lamp is powered by three batteries housed inside the lamp in a battery compartment 39 that easily slides out (FIG. 11) from the right side of the lamp 31. The lamp is simple to use with a single push button 30 that controls all operation. The button turns the lamp on and off and allows the user to select from various lighting modes. The user can choose to turn on varying numbers of bulbs or activate a flashing mode. This allows the user to save energy when performing activities that do not need the full amount of lighting. The beam of light can also be guided by the user by tilting the lamp up (FIG. 8a) and down (FIG. 8b) to the desired angle. When picking up after a dog, one might choose to tilt the lamp down to light the ground near the user's feet, while the person going on an evening hike, might choose to tilt the LED lamp 29 further up to see in the distance. Because the current embodiments of the belt with light are made of non-stretch belt webbing 26A materials, runners can adjust the belts to fit snug around the waist to avoid having a bouncing light as they might with elastic material. Future embodiments for non-athletes could be made of elastic material.

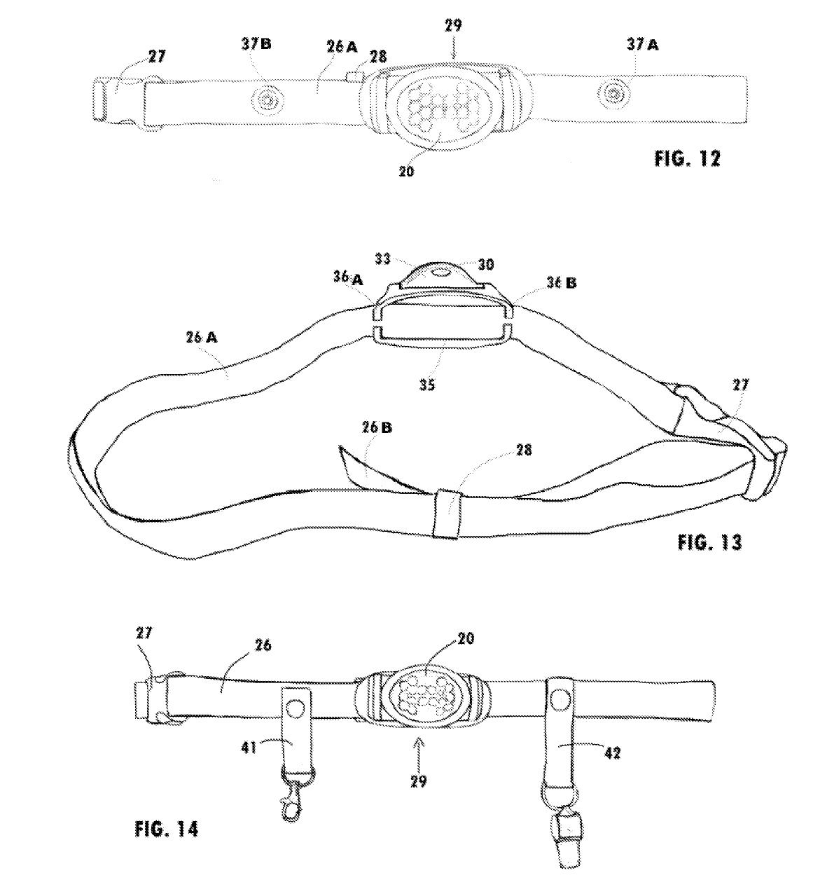

The second embodiment of the belt are depicted in FIGS. 12 through 14. The second embodiment shares all the features of the first embodiment. It is an adjustable belt with light 19 worn around the waist with an LED lamp 29 attached to the front center of the belt webbing 26A material as depicted in FIG. 9. The LED lamp 29 has a plurality of LED bulbs and has a removable battery compartment 39 inside the lamp to house the batteries. The belt is secured by a side release plastic belt buckle 27 which is adjustable on one side. The added feature of this embodiment is the inclusion of snaps 37A and 37B which may be permanently attached to the belt on both sides of the LED lamp 29. This embodiment includes two metal snaps, although more snaps may be included.

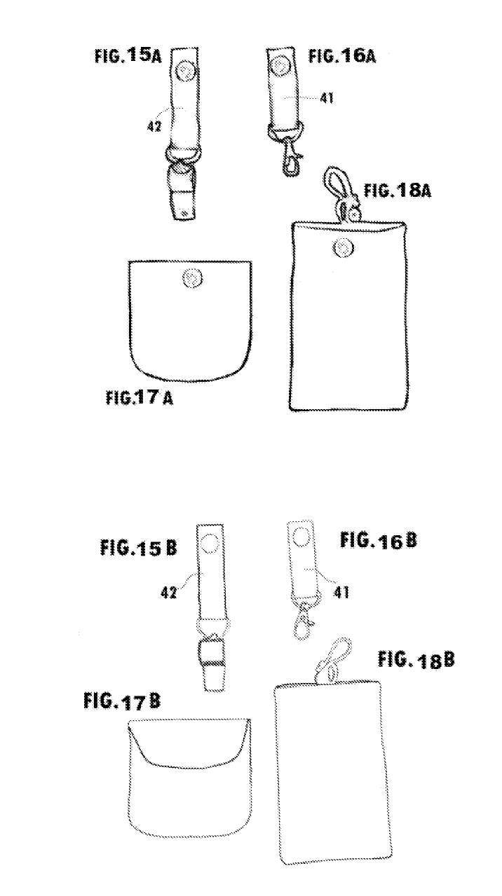

Operation of the second embodiment of the belt with light is similar to that of the first embodiment, with one additional feature. Users are able to attach, by means of “snapping on” accessories to the snaps 37A and 37B permanently embedded in their belt with light. The accessories are things that the user may need for convenience and safety. Current accessories include, but are not limited to: a metal whistle (FIG. 15A-15B), a keychain (FIG. 16A-16B), a small pouch (FIG. 17A-17B) and a larger bag or pouch (FIG. 18A-18B.) FIG. 14 shows two accessories snapped onto the left belt snap 37B and the right belt snap 37A.

One can see that the embodiments of the belt with light provide bright hands-free illumination for people of all ages and most sizes. The illumination reaches over 12 meters and the uses of the present embodiments of the invention are diverse.

While the above description contains several specificities, these should not be construed as limitations on the scope, but rather as examples of two embodiments of this invention. Other variations are possible. The bulb colors will be all white or a combination of white and red bulbs with various modes of operation. The one constant is that the lamps on the belt with light can be energy efficient to provide very bright illumination with low power consumption. Another constant is that the lamps is self-contained without wires connecting to outer power sources. Currently, the power is provided by batteries inside the lamp. Solar powered lamps are considered as an option as long as they provide adequate lighting and they are simple to use and comfortable to wear on the belt. The ease of use and ability to tilt the lamp up and down are characteristics that are foreseen in future embodiments. The belt should remain adjustable and other future embodiments may include reflective material.

The second embodiment of the present invention added the convenience of carrying accessories attached to the belt. Other accessories (not shown) may include: clips for mp3 players and cell phones, plastic doggie bag holders and running snack holders to name a few. The accessories will continue to be attached with metals snaps or other fasteners such as clips or hook and loop type fasteners.

What is claimed:

1. A belt with lighting apparatus and belt buckle, wherein,
the lighting apparatus is disposed on an outer front portion of the belt in a place where traditional belt buckles are disposed,
the lighting apparatus is capable of pivoting a light source up and down;
the belt is made of non-stretch belt webbing;
the lighting apparatus contains a battery compartment within the lighting apparatus; and
the lighting apparatus contains a switch disposed on the lighting apparatus for activating the light source of the lighting apparatus, preferably in the form of a push-button.

2. The belt with lighting apparatus and belt buckle of claim 1, wherein the non-stretch webbing is one inch wide.

3. The belt with lighting apparatus and belt buckle of claim 1, wherein the belt buckle is an adjustable side-release plastic buckle.

4. The belt with lighting apparatus and belt buckle of claim 1, further comprising a plastic belt keeper.

5. The belt with lighting apparatus and belt buckle of claim 1, wherein the belt is adjustable and includes excess belt webbing, preferably about 23 cm in length, which is looped through an adjustable side-release plastic buckle and held in place by a plastic belt keeper.

6. The belt with lighting apparatus and belt buckle of claim 1, wherein the lighting apparatus is a bright, energy-efficient, light-emitting diode (LED) lamp with a plurality of LED bulbs.

7. The belt with lighting apparatus and belt buckle of claim 1, wherein the switch, preferably in the form of a push-button, is disposed on a top of the lighting apparatus.

8. The belt with lighting apparatus and belt buckle of claim 1, wherein the lighting apparatus is secured onto the belt by looping the belt webbing through at least two hooks located on a rear side of the lighting apparatus.

9. The belt with lighting apparatus and belt buckle of claim 1, wherein the battery compartment is disposed on a side of the lighting apparatus and twists loose and slides out.

10. The belt with lighting apparatus and belt buckle of claim 1, wherein the lighting apparatus is a light-emitting diode lamp with a plurality of LED bulbs.

11. The belt with lighting apparatus and belt buckle of claim 1, further comprising at least one snap fastener to attach accessories such as metal whistle, a keychain, a small pouch, or a large bag or pouch.
